(19) United States
(12) Patent Application Publication
(10) Pub. No.: US 2003/0122377 A1
(43) Pub. Date: Jul. 3, 2003

(54) Tube coupling assembly

(76) Inventors: William F. Northrop, Cambridge, MA (US); David C. Hottle, Needham, MA (US)

Correspondence Address: ROBERT W. DIEHL, 311 S. WACKER DRIVE, 53RD FLOOR, CHICAGO, IL, 60606-6622, US

(21) Appl. No.: 10/321,323

(22) Filed: Dec. 17, 2002

Related U.S. Application Data
(60) Provisional application No. 60/344,145, filed on Dec. 27, 2001.

(51) Int. Cl. F16L 17/00

(52) U.S. Cl. 285/363; 285/367

(57) ABSTRACT

The present invention is directed to a coupling assembly for sealingly coupling a first tube and a second tube. The coupling assembly comprises a first and a second tubular fitting, a flange on the first tubular fitting, a flange on the second tubular fitting, and a gasket. The assembly is preferably sealed by a clamp. The first tubular fitting has a proximal end for receiving a first tube and a distal end bearing the flange. The flange has a protective ridge thereon which extends outwardly from the flange. The second tubular fitting also has a proximal end for receiving a second tube and a distal end for bearing a flange. The flange of the second tubular fitting has a recess therein which is non-contiguous to the inside of the second tubular fitting. The ridge of the flange of the first tubular fitting projects into the recess of the flange of the second tubular fitting to form a close fit and partially filling the depth of the recess to form a gasket space. The gasket is disposed in the gasket space of the recess and ridge arrangement. When a clamp is applied to exert lateral force on the two flanges, the ridge is forced into the recess thereby compressing the gasket to provide a seal between the first tubular fitting and the second tubular fitting.

### RELATED APPLICATIONS

This application claims priority of U.S. Provisional Application Serial No. 60/344,145, filed Dec. 27, 2001.

### TECHNICAL FIELD

The present invention relates to a tube coupling assembly, and in particular, a high temperature and high pressure pneumatic tube coupling assembly. Specifically, the assembly is designed to provide easy disassembly, a compact size, low weight, moderate pressure tolerance, high temperature resistance, and a non-leaking seal.

### BACKGROUND ART

Fuel cells continue to play an increasingly important role in power generation for both stationary and transportation applications. A primary advantage of fuel cells is their highly efficient operation which, unlike today's heat engines, are not limited by Carnot cycle efficiency. Furthermore, fuel cells far surpass any known energy conversion device in their purity of operation. Fuel cells are chemical power sources in which electrical power is generated in a chemical reaction between a reducer (hydrogen) and an oxidizer (oxygen) which are fed to the fuel cells at a rate proportional to the power load. Therefore, fuel cells need both oxygen and a source of hydrogen to function. These gases are fed to the fuel cell from their respective sources at high temperatures and under high pressures.

Hydrogen may be fed from a reformer that generates the hydrogen by splitting a hydrocarbon such as ethanol or gasoline. The combination of a fuel cell and a fuel reformer is sometimes known as a fuel cell power system (herein a “power system” for brevity.) The reforming reaction is well known, and involves the reaction of the fuel with steam at high temperatures (600-1,000° C., for example), at pressures typically in the range of 1 to 10 atmospheres. An intermediate product of fuel reformation is carbon monoxide. Since hydrogen is flammable, carbon monoxide is toxic, and oxygen is combustible, suitable couplings must be provided for joining together the various internal tubes of the power system without leakage.

A coupling assembly is generally comprised of two flanges held in a mating relationship by a clamp. Preferably, a seal member is employed between the mated flanges. The couplings must be able to withstand the high temperatures and high pressures required by the power system. These couplings must also be very compact and light weight, due to limited space and weight available for the power system in, for example, an automobile. Prior art devices have failed to meet both the temperature and pressure requirements, and typically do not accommodate space and weight considerations.

In some tube coupling assembly applications where space and weight are not a significant concern, ASME (American Society of Mechanical Engineering) style flanges can be used. The couplings employing these flanges are used commonly in the process industry. The ASME flanges are very cumbersome and difficult to assemble and reassemble. In addition, they are bulky and are not necessarily applicable to use for fuel cell applications, such as in onboard automotive use.

More compact designs are used when weight or volume is an issue, for example in the aerospace industry for carrying hot compressed air. One example of aerospace design is described in SAE (Society of Aerospace Engineering) Design Standard AS1895. In this design, one of the mating flanges typically includes an axially projecting rib, which abuts the opposite mating flange. A metal seal of one of various configurations including “C,” “V,” and “E” shaped configurations is disposed radially between the flanges. In this design, the interior side of the metal seal is exposed to the fluid carried within the coupled tubes. A V-shaped clamping band is also used to clamp together the mating flanges. These flanges are designed to handle high temperatures but allow a small percentage of fluid leakage. (The leakage is tolerable in return for minimization of expense, and is not hazardous.) They are not suitable to handle high pressures or fluids that are dangerous. Moreover, since the metal seal in this design is exposed to the fluid carried within the tubes, it is subject to corrosion if the fluid is reactive, especially under high temperatures and pressures. In the case of the power system, and especially the steam reforming reaction, hot reactive gasses can react with the metal of the seal to form a metal oxide that eventually weakens the seal (in addition to the possibility of leakage).

In U.S. Pat. No. 5,470,114, Umney et al. discloses a coupling assembly for gas turbine engines for pipes or tubes therein for channeling bleed air, fuel, and oil. The flanges in this coupling are based on the ASME flanges described above. An annular elastomeric seal in the form of a conventional O-ring is disposed between the flanges for providing a leak-proof coupling upon clamping together of the two fittings by a clamping band. Upon the assembly of the mating flanges, the seal is compressed and flattened into an oblong cross section for providing an effective sealing joint between the counterbore and the pilot tube. The seal is required to be elastomeric to prevent leakage past opposed metal faces. However, elastomeric materials are generally inadequate to withstand the temperatures and corrosiveness of the fluids in a power system, particularly in a fuel reformer. Moreover, the mechanism of sealing is by an elastomeric O-ring, in which the force for sealing is from the elasticity of the compressed O-ring and not from the clamping band. As will be seen, this is different than the graphite or similar gasket used in the present invention, and the sealing force will be derived from the force applied to the clamping band.

The present invention is directed to a new coupling design for use where easy assembly and disassembly, compact size, low weight, high temperature resistance, and a non-leaking seal are desired. A new sealing surface is presented to help accomplish these desired advantages.

### SUMMARY OF THE INVENTION

A new tube coupling assembly for sealingly coupling a first tube and a second tube in a high-temperature, high-pressure, potentially corrosive environment is disclosed. The coupling assembly comprises a first tubular fitting having an inner surface, an outer surface, a first end configured to receive a first tube, and a second end bearing a flange extending perpendicularly outward from the outer surface and having a ridge thereon, the ridge being contiguous with the inner surface of the fitting and extending a distance outwardly from the flange in a direction perpendicular to the extension of the flange. The coupling assembly also comprises a second tubular fitting abutting the first tubular fitting and having an inner surface, an outer surface, a first end configured to receive a second tube, and a second end bearing a flange extending perpendicularly outward from the outer surface and having a recess therein, the recess being contiguous with the inner surface of the fitting, configured to receive the ridge of the flange of the first tubular fitting, and having a depth less than the distance of the ridge. As an additional component, a gasket is disposed between a surface of the flange of the first tubular fitting and the flange of the second tubular fitting such that the gasket is non-contiguous with the inner surface of either tubular fitting, and a clamp contacts and exerts a lateral force on a surface of each of the two flanges, the force being translated by the flange such that the gasket is compressed to provide a seal between the first tubular fitting and the second tubular fitting.

The components of the tube coupling assembly, such as the first tubular fitting, the second tubular fitting, and the flange of each fitting, may be composed of a material selected from one of either a metal or an alloy, wherein the metal or alloy is resistant to corrosion at temperatures in excess of 200° C. Such metal alloys may include stainless steel, a nickel alloy, and an alloy comprising iron and aluminum.

It is an aspect of an embodiment of the present invention to provide a gasket comprised of a material resistant to temperatures of at least 200° C. Such material may include at least one of the materials selected from the group consisting of a graphite, a fibrous aluminosilicate, and a mica.

It is an aspect of the present invention that any of the embodiments of the coupling assembly described may be used in a fuel cell power system, or any component thereof.

Alternatively, as another embodiment of the new tube coupling assembly for sealingly coupling a first tube and a second tube, the first recess may be non-contiguous with either the inner surface or the outer surface of the second tubular fitting, configured to receive the first ridge of the flange of the first tubular fitting, and having a depth less than the distance of the first ridge to thereby form a gasket space.

Such an embodiment may comprise a second ridge on an end of the flange of the first tubular fitting opposite the first ridge and extending in a direction substantially identical to the first ridge, and a second recess on an end of the flange of the second tubular fitting opposite the first recess such that the second recess accommodates the second ridge.

Other features and advantages of the invention will become apparent from the following description taken in conjunction with the appended drawings.

### BRIEF DESCRIPTION OF THE DRAWINGS

The present invention can be more readily understood with reference to the accompanying drawings, in which like numerals are employed to designate like components throughout the disclosure, and where:

FIG. 1 is an exploded perspective view of one exemplary embodiment of the present invention showing two tubular fittings, a gasket, and a two-piece clamp;

FIG. 2 is a cross-section of an exploded arrangement of the tubular fittings and gasket components shown in the embodiment of FIG. 1;

FIG. 3 is a cross-section of an assembled arrangement of the components shown in FIG. 2, and including a clamp;

FIG. 4 is an exploded perspective view of another exemplary embodiment of the tube coupling assembly in accordance with the present invention;

FIG. 5 is an exploded sectional view of the unassembled tube coupling assembly of FIG. 4 without the clamp;

FIG. 6 is a cross-sectional view of the tube coupling assembly of FIG. 5, including the clamp; and

FIG. 7 is a cross-sectional view of a conventional prior art tube coupling assembly.

### DETAILED DESCRIPTION OF PREFERRED EMBODIMENTS

While this invention is susceptible of embodiments in many different forms, and will herein be described in detail, preferred embodiments of the invention are disclosed with the understanding that the present disclosure is to be considered an exemplification of the principles of the invention and is not intended to limit the broad aspects of the invention to the specific embodiments illustrated. While the tube coupling assembly is primarily designed for and will hereinafter be described in connection with its use in fuel cell systems to carry highly reactive fluids at high temperatures and pressures, it should be appreciated that the assembly can be used in various other applications in which it is necessary to secure two tubular elements together.

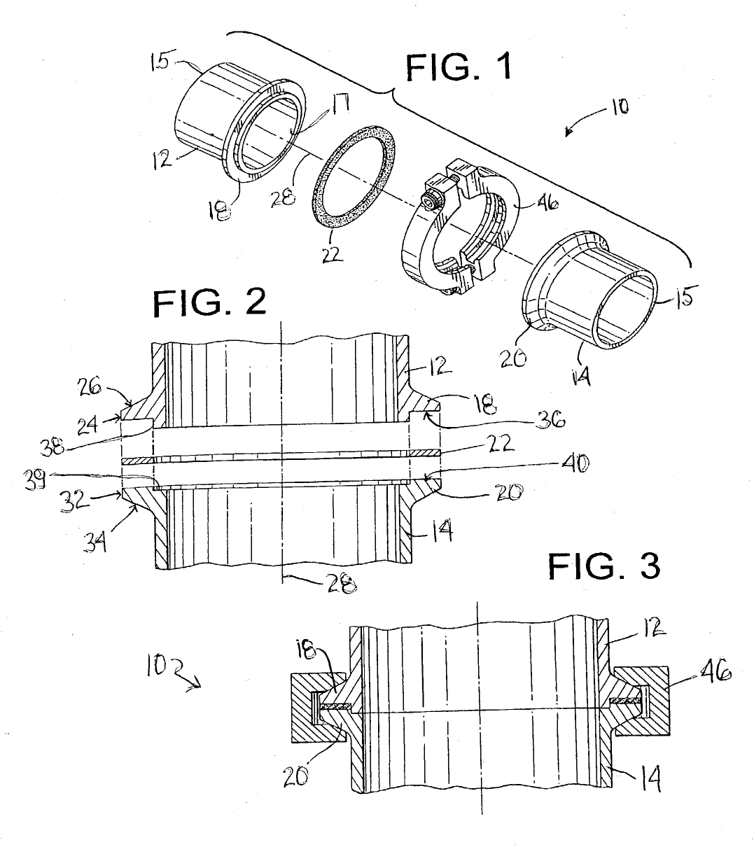

Referring generally to the appended FIGS. 1-6, the coupling assembly for sealingly coupling two tubes in a fuel reforming system can be more readily understood. The disclosed assembly is generally referenced by the number “10” in the following disclosure and drawings. Other components are similarly and consistently numbered throughout the specification and drawings. While the present invention is particularly designed for use with a high-temperature, high-pressure fuel reforming system, such as, for example, any system or system component disclosed in U.S. Pat. Nos. 6,083,425, 6,123,913, 6,126,908, 6,207,122, 6,245,303, 6,254,839, or their progeny, each assigned to designed by Nuvera Fuel Cells of Cambridge, Mass., other such systems and system components may be capable of adaptation for implementation of the tube coupling assembly as well.

As shown in FIG. 1, the present assembly 10 is generally comprised of a first tubular fitting 12 having a first or proximal end 15 for receiving a first tube 16a and a second or distal end 17 bearing a flange 18. A second tubular fitting 14 similarly has a first or proximal end 15 for receiving a second tube 16b and a second or distal end 17 bearing a flange 20. The tube 16a and tube 16b are sealingly joined to the respective proximal ends of the fittings 12 and 14 by any method known in the art, such as welding. The flanges 18 and 20 are annularly disposed about the distal end of each tubular fitting 12 and 14, respectively. Each flange 18 and 20 is comprised of several components common to both: two opposing surfaces—an inclined clamping surface 26 and 34, respectively, and a contact surface 36 and 40, respectively—and a juxtapositioned third surface—flat exterior surface 24 and 32, respectively.

A gasket 22 is disposed between the two flanges 18 and 20 to be sandwiched by the contact surfaces 36 and 40 of each, respectively, as the fittings 12 and 14 are mated. A clamp 24 is used to exert lateral force on the mating flanges 18 and 20 at the inclined clamping surfaces 26 and thereby compress the gasket 22 to provide a seal between the first tubular fitting 12 and the second tubular fitting 14.

The detailed features of the coupling assembly 10 are shown in FIG. 2, which is an unassembled exploded cross-sectional view of the embodiment of FIG. 1. The flange 18 includes the flat exterior surface 24 extending parallel to an axial centerline 28 of the coupling assembly 10. An inclined clamping surface 26 is disposed adjacent to the flat exterior surface 24 to provide a biasing aspect to the coupling assembly 10. An annular contact surface 36 is disposed opposite the inclined clamping surface 26, and a recess 39 is positioned at the inner side of contact surface 36.

Similarly, the flange 20 includes a flat exterior surface 32 extending parallel to the axial center line 28 and adjacent an inclined clamping surface 34. The flat exterior surface 32 of the flange 20 is complementary in configuration to the flat exterior surface 24 of flange 18. The flange 20 also includes an annular contact surface 40 disposed opposite the inclined clamping surface 34 and extending radially and inwardly from the flat exterior surface 32. The contact surface 40 is non-contiguous to the inside of the second tube 16b, but is contiguous to the flat exterior surface 32. The annular contact surface 40 abuts a protective ridge 38 disposed along the entire inside circumference of the surface 40. As shown in FIGS. 2 and 3, the contact surface 40 and protective ridge 38 collectively form a gasket space open at the side proximate the exterior surface 32. While the drawing figures illustrate a substantially squared protective ridge 38 on fitting 14 and complementary recess 39 on fitting 12, rounded, crenate, crenellated, or other similar forms may be used to provide the necessary protective barrier, as discussed below.

When the coupling assembly 10 is assembled, as shown in FIG. 3, the contact surface 36 of the flange 18 projects into the gasket space to form a close fit on the inside edge while only partially filling the depth of the space. The unfilled volume of the gasket space between the contact surface 36 and the contact surface 40 is to be filled by the use of gasket 22.

A gasket 22 is disposed within the gasket space to, preferably, tightly fill the space both at the edges and depth-wise. When the coupling 10 is assembled, the flat exterior surface 24 is preferably flush with the outer edge of the gasket 22 and the flat exterior surface 32. The protective ridge 38 of fitting 14 sits within the recess 39 adjacent contact surface 36 of flange 18. This configuration acts as a barrier for the gasket 22 as a throughway is formed by the fittings 12 and 14 from one open end to the other open end within which the potentially caustic fluid from the tubes may pass.

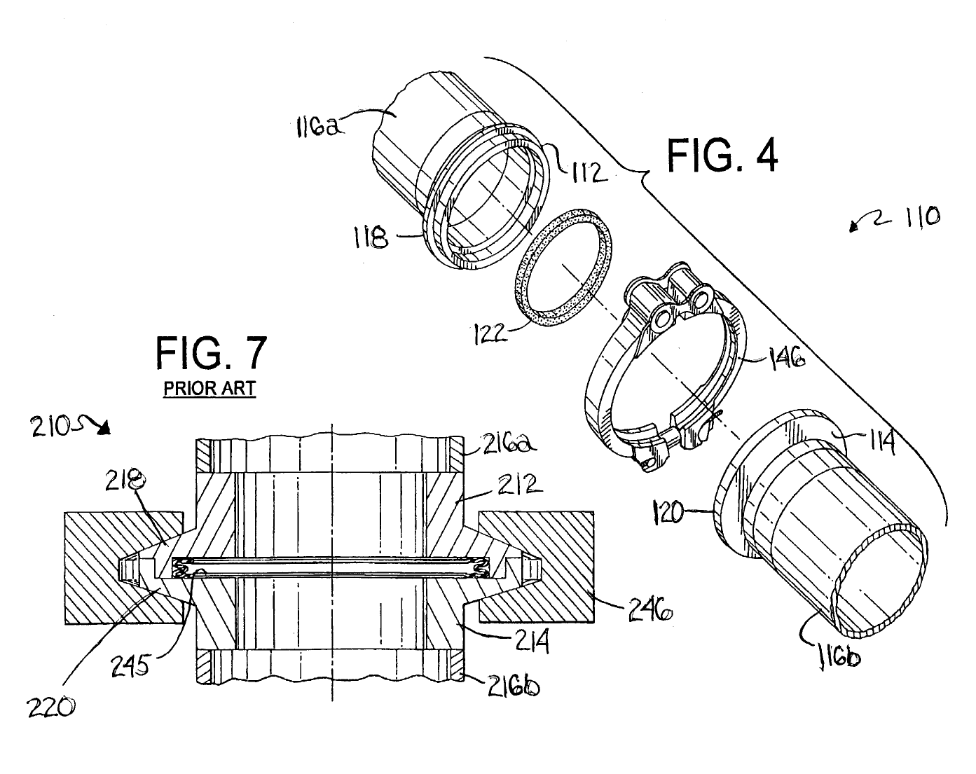

In an alternative embodiment, shown in FIGS. 4-6, the two tubular fittings, 112 and 114, can provide additional sealing protection against outer agents of assembly 110. Referring to FIG. 4, a second protective ridge 142 may be employed on either flange 118 or flange 120 with a second recess 143 on the other flange-the figures only show protective ridge 142 on flange 120 with the second recess 143 on flange 118, but those skilled in the art would understand the possible reversal of these components. The second protective ridge 142 and second recess 143 provide, when assembled, a tortuous path to gasket 122 similar to the inner path provided by protective ridge 138 and recess 139.

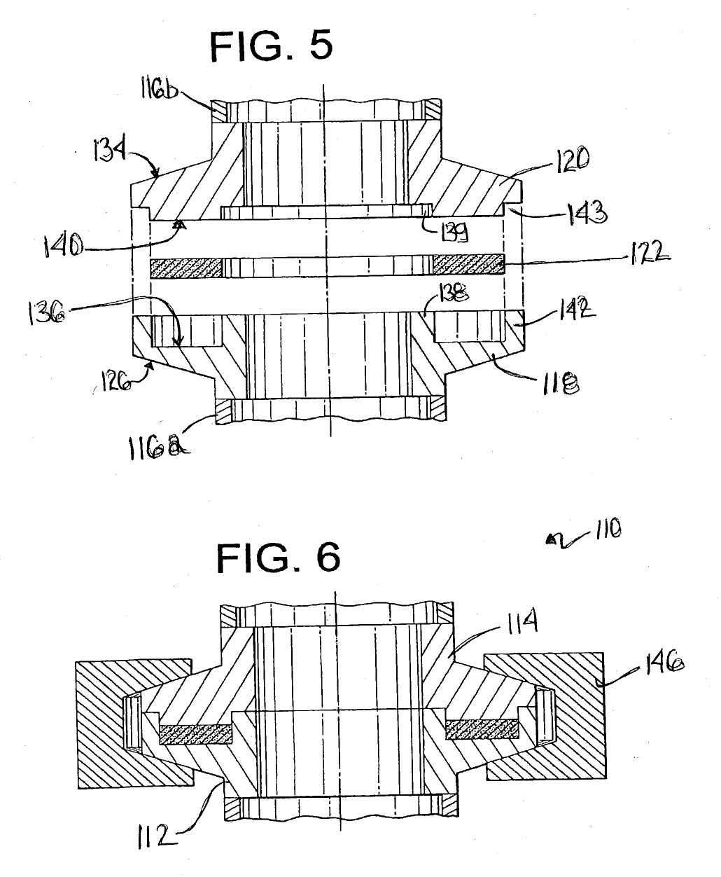

As shown in FIG. 5, fitting 112 and fitting 114 each is comprised of surfaces similar to the previous embodiment (FIGS. 1-3). That is, inclined clamping surface 126 of flange 118 and clamping surface 134 of flange 120 cooperate with clamp 146 to force contact surfaces 136 and 140, respectively, together to form a tight seal against gasket 122. This feature is explained further below with respect to FIGS. 1-3.

Where the gasket 122 may have a tendency to extrude out of space or where contact with caustic fluids from the outer surface of the coupling assembly 110 is possible the use of this alternative embodiment may be advantageous.

Obviously, the use of an additional ridge and recess may come at a greater expense to the manufacturer. Presently, the embodiment of FIGS. 1-3 can be machined from a sanitary farrell, while the embodiment of FIGS. 4-6 requires a far more costly fillet. In all other regards the use and variations of the present invention are applicable to either of the disclosed embodiments.

Returning to FIGS. 1-3, the clamp 46 embraces the flanges 18 and 20 of fittings 12 and 14 at the inclined clamping surfaces 26 and 34. When the clamp 46 is tightened by reducing its inner diameter, it exerts a lateral force on the inclined clamping surfaces 26 and 34 which translates the force normal to the tightening direction. This results in the ridge 38 of fitting 12 positioned in the recess 39 of fitting 14 compressing the gasket 22 to provide a tight seal between the first tubular fitting 12 and the second tubular fitting 14. When the tube coupling 10 is fully assembled, the gasket 22 is tightly and concealingly disposed within the gasket space. Preferably, there is no direct exposure of the gasket 22 to the fluid to be carried by the tube 16a and tube 16b to minimize any reactions between the fluid and the gasket 22.

The materials for the first tube 16a, the flange 18, the second tube 16b, and the flange 20 must be made of a material which is resistant to corrosion at temperatures in excess of 200° C., and more preferably 400° C. or higher. The material is most typically a metallic material, although ceramics and composites can be used if the extra expense can be justified. A metallic material comprises a metal, and is typically an alloy of different metals. The metallic material can be selected from a wide variety of high temperature resistant metals, which are well known in the art. Suitable materials are discussed in, for example, the “Chemical Engineer's Handbook”, Fifth Edition (Published by McGraw-Hill Books Co.). In the Fifth Edition thereof, edited by Chilton & Perry, appropriate materials and indications for their selection are extensively described in Chapter 23, particularly on pages 14 through 61, the details of which are hereby incorporated by reference. Commonly used alloys in fuel reformers include stainless steels, particularly 300-series stainless steels such as 304 and 316 types. For the highest temperatures, as found in some portions of reformers, specialty high temperature alloys are commonly used, such as nickel alloys (e.g., Inconel, Hastalloy, Haynes and other brands) and other more exotic hybrids. In general, it is preferred to make the flanges of the same metal, alloy or other material as is used to make the tubing which is to be coupled.

The gasket 22 is preferably composed of a material resistant to temperatures higher than 200° C. Various materials are known that can resist these conditions. In particular, graphite, fibrous aluminosilicates, and micas are known to be suitable components of high temperature gaskets. Composites of these materials with each other (e.g. graphite-impregnated aluminosilicates) or with other materials and fillers, such as metals or ceramics, in fibrous and/or particulate form, are also suitable. A preferred material component for the gasket 22 is a graphite, optionally with a reinforcing fibrous or metal material.

The clamp 46 can be any clamp that is capable of exerting a lateral force on the flange 18 and flange 20 to force the ridge 38 of the fitting 12 into the recess 39 of the fitting 14. The clamp 46 should preferably be light-weight and easy to assemble and disassemble. It is preferably a circumferentially contractible clamp employing nut and bolt arrangements to tighten around the inclined surfaces 26 and 34 of the respective flanges 18 and 20. Two suitable mechanisms are illustrated in FIGS. 1-3, a double “C” clamp arrangement bolted at both junctions, and FIGS. 4-6, a hinged collar device having a locking and tightening mechanism at the opening junction. Commercially available clamps used in V-retainer coupling assemblies, for example, are suitable for the present invention.

FIG. 7 is a cross-sectional view of a conventional prior art tube coupling assembly 210 employed in the aerospace industry for carrying compressor bleed air, fuel, and lubricating oil. FIG. 7 shows that the first flat surface 236 of the flange 218 and the second flat surface 240 of the flange 220 are both subjected to the axially directed pressure forces from the fluid carried by the tube 216a and tube 216b. The seal 245, being disposable between the flanges, is an O-ring composed of either an elastomeric material, or a metal shaped to provide flexibility, such as a C-shape, a V-shape, or an E-shape. The seal 245 is in direct contact with the sealing surfaces 236 and 240. The elasticity or the flexibility of these rings provides the seal within the cavity between the flat surface 236 of flange 218 and the flat surface 240 of the flange 220 with or without the clamp 246.

The clamp 246 functions mainly to hold the units together and further secures the seal provided by the O-ring. This is distinguishably different than the present invention in which a gasket is used as the seal. The gasket itself, which is neither elastic nor flexible, does not provide the seal. The seal is provided from the lateral force from the clamp 246 on the flanges when the clamp 246 is tightened. Furthermore, the seal 245 of the prior art, shown in the cross section of FIG. 7 as an E-shaped metal O-ring, is exposed to the fluid passing through the tube 216a and tube 216b and may, thus, react with the fluid, especially when the fluid is reactive. The prior art coupling assembly 210 is not adapted to applications under conditions of high temperatures and high pressures such as those used in fuel cells or fuel reformers.

One of the advantages of the improved coupling of the present invention is that, in contrast to the prior art designs, the gasket is protected by a tortuous path from attack by the fluids carried in the tube. This effectively minimizes the rate of any erosion of the gasket that may occur under high temperature operation.

It is understood that, given the above description of the embodiments of the invention, various modifications may be made by one skilled in the art without departing from the spirit and scope of the appended claims. Such modifications are intended to be encompassed by the claims below.

What is claimed is:

1. A tube coupling assembly for sealingly coupling a first tube and a second tube, the coupling assembly comprising:
a first tubular fitting having an inner surface, an outer surface, a first end configured to receive a first tube, and a second end bearing a flange extending perpendicularly outward from the outer surface and having a ridge thereon, the ridge being contiguous with the inner surface of the fitting and extending a distance outwardly from the flange in a direction perpendicular to the extension of the flange;
a second tubular fitting abutting the first tubular fitting and having an inner surface, an outer surface, a first end configured to receive a second tube, and a second end bearing a flange extending perpendicularly outward from the outer surface and having a recess therein, the recess being contiguous with the inner surface of the fitting, configured to receive the ridge of the flange of the first tubular fitting, and having a depth less than the distance of the ridge;
a gasket disposed between a surface of the flange of the first tubular fitting and the flange of the second tubular fitting such that the gasket is non-contiguous with the inner surface of either tubular fitting; and
a clamp contacting and exerting a lateral force on a surface of each of the two flanges, the force being translated by the flange such that the gasket is compressed to provide a seal between the first tubular fitting and the second tubular fitting.

2. The tube coupling assembly of claim 1, wherein the material of the first tubular fitting, the second tubular fitting, and the flange of each fitting is comprised of either a metal or an alloy, wherein the metal or alloy is resistant to corrosion at temperatures in excess of 200° C.

3. The tube coupling assembly of claim 2, wherein the material of the first tubular fitting, the second tubular fitting, and the flange of each fitting is comprised of an alloy selected from the group consisting of stainless steel, a nickel alloy, and an alloy comprising iron and aluminum.

4. The tube coupling assembly of claim 1, wherein the gasket is comprised of a material resistant to temperatures higher than 200° C.

5. The tube coupling assembly of claim 4, wherein the gasket is comprised of at least one of the materials selected from the group consisting of a graphite, a fibrous aluminosilicate, and a mica.

6. The tube coupling assembly of claim 1, wherein the protective ridge is crenate in cross section.

7. The tube coupling assembly of claim 1, wherein the protective ridge is crenellated in cross section.

8. The tube coupling assembly of claim 1, wherein the protective ridge is rounded in cross section.

9. A fuel cell power system, or a component thereof, comprising at least one coupling using the coupling assembly of claim 1.

10. A fuel cell power system, or a component thereof, comprising at least one coupling using the coupling assembly of claim 3.

11. A fuel cell power system, or a component thereof, comprising at least one coupling using the coupling assembly of claim 5.

12. A tube coupling assembly for sealingly coupling a first tube and a second tube, the coupling assembly comprising:
a first tubular fitting having an inner surface, an outer surface, a first end configured to receive a first tube, and a second end bearing a flange extending perpendicularly outward from the outer surface and having a first ridge thereon, the first ridge being contiguous with the inner surface of the fitting and extending a distance outwardly from the flange in a direction perpendicular to the extension of the flange
a second tubular fitting coupled to the first tubular fitting and having an inner surface, an outer surface, a first end configured to receive a second tube, and a second end bearing a flange extending perpendicularly outward from the outer surface and having a first recess therein, the first recess being non-contiguous with either the inner surface or the outer surface of the second tubular fitting, configured to receive the first ridge of the flange of the first tubular fitting, and having a depth less than the distance of the first ridge to thereby form a gasket space;
a gasket disposed in the gasket space; and
a clamp contacting and exerting a lateral force on the coupled flanges, the ridge of the flange being forced into the recess of the flange, thereby compressing the gasket to provide a seal between the first tubular fitting and the second tubular fitting.

13. The tube coupling assembly of claim 12, further comprising:
a second ridge on an end of the flange of the first tubular fitting opposite the first ridge and extending in a direction substantially identical to the first ridge, and
a second recess on an end of the flange of the second tubular fitting opposite the first recess such that the second recess accommodates the second ridge.

14. The tube coupling assembly of claim 13, wherein the material of the first tubular fitting, the second tubular fitting, and the flange of each fitting is comprised of an alloy selected from the group consisting of stainless steel, a nickel alloy, and an alloy comprising iron and aluminum.

15. The tube coupling assembly of claim 13, wherein the gasket is comprised of
a material resistant to temperatures of at least 200° C.

16. The tube coupling assembly of claim 15, wherein the gasket is comprised of at least one of the materials selected from the group consisting of a graphite, a fibrous aluminosilicate, and a mica.

17. The tube coupling assembly of claim 13, wherein at least one of either the first or second protective ridge is crenate in cross section.

18. The tube coupling assembly of claim 13, wherein at least one of either the first or second protective ridge is crenellated in cross section.

19. The tube coupling assembly of claim 13, wherein at least one of either the first or second protective ridge is rounded in cross section.

20. A fuel cell power system, or a component thereof, comprising at least one coupling using the coupling assembly of claim 12.

21. A fuel cell power system, or a component thereof, comprising at least one coupling using the coupling assembly of claim 13.

22. A fuel cell power system, or a component thereof, comprising at least one coupling using the coupling assembly of claim 15.
